(19) United States
(12) Patent Application Publication
(10) Pub. No.: US 2025/0183560 A1
(43) Pub. Date: Jun. 5, 2025

(54) WALL PLATE SYSTEMS AND ARRANGEMENTS

(71) Applicant: LEVITON MANUFACTURING CO., INC., Melville, NY (US)

(72) Inventors: Nicholas Pilato, Forest Hills, NY (US); Michael Kamor, North Massapequa, NY (US); Shuming Teoh, Huntington, NY (US)

(73) Assignee: LEVITON MANUFACTURING CO., INC., Melville, NY (US)

(21) Appl. No.: 18/845,501

(22) PCT Filed: Feb. 22, 2023
(86) PCT No.: PCT/US2023/013599

§ 371 Date: Sep. 10, 2024

Related U.S. Application Data
(60) Provisional application No. 63/320,280, filed on Mar. 16, 2022.

(51) Int. Cl. H01R 4/48; H02G 3/16

(52) U.S. Cl. CPC H01R 4/48; H02G 3/16

(57) ABSTRACT

A wall plate system having a wall plate adapted to accommodate one or more devices that draw power from power terminals of an in-wall device and may comprise wall plate connectors to couple with power rails in a configurable frame. The configurable frame to attach to the in-wall device. the configurable frame comprising: one or more power support members coupled with terminal connectors to provide a force towards the in-wall device to maintain electrical connections between contacts of the terminal connectors and the power terminals: two or more power rails electrically connected to the contacts of the terminal connectors: and two or more contacts coupled with one or more power support members. the two or more contacts to couple with wall plate connectors in response to connection of the wall plate to the configurable frame.

### CROSS-REFERENCE TO RELATED APPLICATIONS

This application is a utility patent application for pending U.S. provisional patent application No. 63/320,280, filed Mar. 16, 2022, entitled “WALL PLATE SYSTEMS AND ARRANGEMENTS”, which is hereby incorporated by reference into the present application in its entirety.

### FIELD OF THE DISCLOSURE

The present disclosure relates generally to a wall plate, more particularly, to wall plate systems and arrangements that include one or more devices that draw power from terminals of mounted electrical devices such as electrical outlets.

### BACKGROUND OF THE DISCLOSURE

In-wall devices may include devices such as switches and outlets. Switches may include an in-wall load control device such as a toggle/paddle switch, a dimmer switch, etc. and can be used to control one or more loads such as a lighting load or a motor load such as a fan. Outlets may include, e.g., electrical power outlets, data cable outlets, satellite/cable television outlets, security video outlets, adapters, splitters, transformers, etc. Typically, each in-wall device includes a conventional wall plate. Conventional wall plates are essentially decorative and provide no function other than to aesthetically cover any holes within a wall used to install the in-wall device. While conventional wall plates are often found throughout spaces in accessible locations, conventional wall plate surfaces are very limited in functionality.

Thus, it would be desirable to provide wall plate systems and arrangements within a space that has traditionally remained unutilized.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

A wall plate apparatus for attaching to an in-wall wiring device, the wall plate comprising: a frame having a wiring device aperture for receiving the in-wall wiring device when the frame is attached to the in-wall wiring device; a power support member coupled to a surface of the frame; a plurality of power rails coupled to the power support member; a plurality of terminal connectors, wherein the plurality of terminal connectors are each slidably coupled to, and in electrical communication with, a respective power rail the plurality of power rails, wherein the plurality of terminal connectors are each configured to establish electrical communication with corresponding power terminals of the in-wall wiring device when the frame is attached to the in-wall wiring device; and a wall-plate electrical device coupled to the plurality of power rails.

A wall plate system, comprising: a configurable frame to attach to an in-wall wiring device, the configurable frame having an opening for the in-wall wiring device, the in-wall wiring device comprising power terminals on at least one side of the in-wall wiring device, the configurable frame comprising: two or more power rails comprising an electrically conductive material; two or more terminal connectors comprising electrically conductive contacts, wherein each of the terminal connectors is configured to connect to a different one of the two or more power rails; the one or more power support members coupled with terminal connectors to provide a force towards the in-wall wiring device to maintain electrical connections between the electrically conductive contacts and the power terminals, wherein each of the one or more power support members comprises an electrically insulative material between the two or more power rails to insulate the two or more power rails from each other; and two or more hidden contacts coupled with the two or more power rails, the two or more hidden contacts to become at least partially exposed to one or more wall plate connectors in response to connection of a wall plate to the configurable frame, wherein each of the two or more hidden contacts is electrically connected to a different rail of the two or more power rails; the wall plate comprising one or more devices and the one or more wall plate connectors, the one or more wall plate connectors comprising electrically conductive protrusions to connect to the two or more hidden contacts.

A wall plate system, comprising: an in-wall electrical outlet having two or more power terminals on at least one side of the in-wall electrical outlet; a configurable frame to attach to the in-wall electrical outlet, the configurable frame having an opening for the in-wall electrical outlet, the configurable frame comprising: two or more power rails comprising an electrically conductive material; two or more terminal connectors comprising electrically conductive contacts, wherein each of the terminal connectors is configured to connect to a different one of the two or more power rails; the one or more power support members coupled with the two or more terminal connectors to provide a force towards the in-wall electrical outlet to maintain electrical connections between the electrically conductive contacts and the two or more power terminals, wherein each of the one or more power support members comprises an electrically insulative material between the two or more power rails to insulate the two or more power rails from each other; and two or more hidden contacts coupled with the two or more power rails, the two or more hidden contacts to become exposed to one or more wall plate connectors in response to connection of a wall plate to the configurable frame, wherein each of the two or more hidden contacts is electrically connected to a different rail of the two or more power rails; the wall plate comprising one or more devices and the one or more wall plate connectors, the one or more wall plate connectors comprising electrically conductive protrusions to connect to the two or more hidden contacts.

### BRIEF DESCRIPTION OF THE DRAWINGS

By way of example, specific embodiments of the disclosed device will now be described, with reference to the accompanying drawings, in which:

FIG. 1A illustrates a front view of an embodiment of a wall plate system;

FIG. 1B illustrates a block diagram of exemplary functional components of the wall plate system depicted in FIG. 1A.

FIG. 2 illustrates a side angle view from the front of components of an embodiment of a wall plate system such as the wall plate system depicted in FIG. 1A;

FIG. 3 illustrates a side angle view from the back of components of an embodiment of a wall plate system such as the wall plate system depicted in FIG. 1A;

FIG. 4 illustrates a front view of a configurable frame of an embodiment of a wall plate system such as the wall plate system depicted in FIG. 1A;

FIG. 5 illustrates a side angle view from the front of a configurable frame of an embodiment of a wall plate system such as the wall plate system depicted in FIG. 1A;

FIG. 6 illustrates another side angle view from the front of a configurable frame of an embodiment of a wall plate system such as the wall plate system depicted in FIG. 1A;

FIG. 7 illustrates another side angle view from the front of a configurable frame of an embodiment of a wall plate system such as the wall plate system depicted in FIG. 1A;

FIG. 8 illustrates another side angle view from the front of a configurable frame of an embodiment of a wall plate system such as the wall plate system depicted in FIG. 1A;

FIG. 9 illustrates a cross-section view from the top of a configurable frame and in-wall device of an embodiment of a wall plate system such as the wall plate system depicted in FIG. 1A;

FIGS. 10A-B illustrates a view from the back of a configurable frame and an angled back side view of an embodiment of a wall plate system such as the wall plate system depicted in FIGS. 1A, 2, and 12;

FIG. 11 illustrates an embodiment of another view of a wall plate attached to a configurable frame to expose a hidden contact of an embodiment of a wall plate system such as the wall plate system depicted in FIGS. 1A, 2, and 12;

FIG. 12 illustrates an illustrates a side angle view from the front of components of an alternative embodiment of a wall plate system such as the wall plate system depicted in FIG. 1A;

FIG. 13 illustrates a front view of a configurable frame of an alternative embodiment of a wall plate system such as the wall plate system depicted in FIG. 1A;

FIG. 14 illustrates another front view of a configurable frame with an in-wall device of an alternative embodiment of a wall plate system such as the wall plate system depicted in FIG. 1A;

FIG. 15 illustrates a back view of a configurable frame with an in-wall device of an alternative embodiment of a wall plate system such as the wall plate system depicted in FIG. 1A;

FIG. 16 illustrates a side angle view from the front of a configurable frame of an alternative embodiment of a wall plate system such as the wall plate system depicted in FIG. 1A;

FIG. 17 illustrates another side angle view from the front of a configurable frame of an alternative embodiment of a wall plate system such as the wall plate system depicted in FIG. 1A;

FIG. 18 illustrates another side angle view from the front of a configurable frame of an alternative embodiment of a wall plate system such as the wall plate system depicted in FIG. 1A; and

FIGS. 19A-C illustrate back views of a configurable frame with three different in-wall devices of embodiments of a wall plate system such as the wall plate system depicted in FIG. 1A.

### DETAILED DESCRIPTION

Devices, systems, and methods in accordance with the present disclosure will now be described more fully hereinafter with reference to the accompanying drawings, in which preferred embodiments of the devices, systems, and methods are shown. The disclosed devices, systems, and method, however, may be embodied in many different forms and should not be construed as being limited to the embodiments set forth herein. Rather, these embodiments are provided so that this disclosure will be thorough and complete, and will fully convey the scope of the devices, systems, and methods to those skilled in the art. In the drawings, like numbers refer to like elements throughout.

The large majority of wall plates today have no function whatsoever except for aesthetics. Adding functionality to this commonly used part could be useful and convenient. There are some manufacturers on the market currently offering wall plates with basic lighting functionality. These wall plates have fixed contacts (fixed both vertically and horizontally) which contact the screw terminals on common electrical outlets (receptacles) such as ground fault current interrupter (GFCI) electrical outlets and arc fault current interrupter (AFCI) electrical outlets. Furthermore, these wall plates are marketed as being able to universally fit electrical outlets.

A technical problem related to these “universal fit” wall plates is that there is currently no standard defining where screw terminals are to be placed on electrical outlets. Without guidance from a standard, the industry has manufactured and continues to manufacture electrical outlets with significant variations in power (screw) terminal placement. Use of such “universal fit” wall plates with electrical outlets that have power terminal placement significantly outside anticipated design parameters for these “universal fit” wall plates could lead to health and safety issues.

Such health and safety issues have drawn the attention of major safety agencies and development of a standard surrounding the design of wall plates has been raised.

Embodiments described herein include wall plate systems and arrangements that can address at least some of these health and safety issues by safely fitting a product line of electrical outlets. Some embodiments may also safely fit competitor product lines of electrical outlets. Some embodiments accomplish the specification of product lines and competitor product lines via adjustability of terminal connectors so they can easily be located into positions needed for specific applications.

Embodiments described herein include wall plate systems and arrangements having (or configurable to include) one or more devices that draw power from the terminals of an in-wall device such as an electrical outlet. The wall plate systems and arrangements may also be adaptable to a variety of different in-wall device sizes and power terminal configurations. For instance, some electrical outlets may include one or two power terminals on a first side of the electrical outlet configured to couple with a power phase wire (such as a black wire), one or two power terminals on a second side of the electrical outlet configured to couple with a neutral wire (such as a white wire), and a ground terminal on, e.g., the same side as the neutral terminal configured to connect to a ground wire (such as a bare copper wire or a green wire). Other electrical outlets may include both power terminals for the power phase and neutral on one side of the electrical outlet. Furthermore, the power terminals may be located at various locations about the height of the electrical outlet.

In many embodiments, the wall plate systems and arrangements may comprise a wall plate adapted to accommodate wall-plate electrical devices, e.g., one or more printed circuit board assemblies (PCBAs) coupled with the wall plate, a light socket, and/or the like. A PCBA may include, for example, a universal serial bus (USB) outlet (typically provided as a power supply), one or more light emitting diodes (LEDs) with an LED driver, and/or other devices. In many embodiments, the PCBA, light socket, and/or connectors electrically attached to the PCBA or socket may include one or more wall plate connectors to electrically interconnect at least two of the power terminals on the in-wall device with the wall plate.

In some embodiments, the wall plate connectors function to partially or fully expose hidden contacts on a configurable frame to interconnect the one or more connectors with two or more power rails on a configurable frame mounted between the wall plate and the in-wall device. The configurable frame may include adjustable terminal connectors, each electrically coupled to one of two or more power rails such as one or more power phases, a neutral rail, or a ground rail.

In some embodiments, each of the wall plate connectors connect to at least one of two or more power rails such as one or more power phase rails, a neutral rail, or a ground rail that slidably receive and electrically couple with terminal connectors. For instance, in one embodiment, the configurable frame may include two power rails, a power phase rail and a neutral rail, and the one or more connectors from the wall plate may connect with the two rails to provide a power phase and neutral to the one or more devices on the wall plate. In some embodiments, the rails may comprise, e.g., copper, copper alloy, or another electrically conductive material.

In other embodiments, the wall-plate electrical devices may couple with the configurable frame and may be powered from the power rails on or in the power support members of the configurable frame. In such embodiments, the wall plate may not include wall plate connectors. In still further embodiments, a portion of the wall-plate electrical devices may be coupled with the configurable frame and a portion of the wall-plate electrical devices may be coupled with the wall plate. In such embodiments, the wall plate may include the wall-plate connectors to electrically connect the wall-plate electrical devices with the power rails of the configurable frame.

In some embodiments, the configurable frame may include one or more power support members to attach to the rails. In some embodiments, the one or more power support members may comprise an electrically insulative material including grooves and the rails may reside in the grooves. The grooves may be separated by an electrically insulative medium to prevent arcing or contact between the rails. In other embodiments, the rails may reside on a surface of the power support members and an electrically insulative medium may reside between the rails.

In some embodiments, the one or more power support members may be in fixed positions. In some embodiments, the one or more power support members may be horizontally adjustable in that the one or more power support members can be located at different locations to narrow or broaden the distance between the power support members, which narrows or broadens the opening for an in-wall device in the configurable frame as well as distances between the terminal connectors on the configurable frame and the power terminals on the in-wall device. In some embodiments, the configurable frame may include one or more springs to apply a spring load force on the power support members towards the in-wall device.

Each of the terminal connectors may include a contact and a slide and, in some embodiments, a spring portion integrated with the contact and/or slide to provide or exert a spring force on the contact toward the power terminals of the in-wall device. The contact may be configured to electrically contact power terminals of an in-wall device and the slide may slidably connect to the power rails on or in the power support members. In some embodiments, the spring portion may be the interconnection between the slide and contact that has a spring action such that the force applied to the terminal contact towards the slide encounters an opposite spring force towards the contact (away from the slide). In some embodiments, the contact and the slide may comprise a single manufactured unit made of one or more materials. For instance, some embodiments may include a single piece, electrically conductive (e.g., copper or copper alloy) slide and contact. In other embodiments, the terminal connector may include an electrically conductive contact coupled with an electrically insulative slide, where the electrically conductive contact is configured to interconnect one of the power rails on or in the power support member with the power terminal on the in-wall device.

The terminal connectors may attach to one or both of the power support members and may electrically connect the contacts of the terminal connectors with two or more of the rails such as a power phase rail and a neutral rail. In many embodiments, the terminal connectors may be vertically adjustable. Such terminal connectors may slide vertically up and down the power support member and remain connected to the rails at least at selected locations along the power support member. In some embodiments, the power support members may comprise ratcheting features. For instance, the power support members may include notches to snap the terminal connectors into place at one or more points along the rails such as two or more locations that are associated with locations of power terminals on in-wall devices. In some embodiments, the terminal connectors may slide between notches that are uniformly distributed along one or more of the power support members between a minimum vertical position and a maximum vertical position. In further embodiments, each terminal connector is configured to connect to only one of the rails on the one or more power support members and will connect to the same rail regardless of the power support member onto which the terminal connector is attached. In some embodiments, the terminal connectors may be marked with an indication of the power rail to which the terminal connector is configured to connect. For instance, the terminal connectors may include labels and/or colors indicative of a power phase rail, a neutral rail, or a ground rail. To illustrate, the terminal connector for a power phase rail may be or may include a black color or an indication thereof, the terminal connector for a neutral rail may be or may include a white color or an indication thereof, and the terminal connector for a ground rail may be or may include a green color or an indication thereof.

The one or more power support members may, in some embodiments, reside in a primary plane or a plane parallel to the primary plane of the configurable frame. In some embodiments, the one or more power support members may couple with one or more walls that may reside in a plane perpendicular to the primary plane of the configurable frame. The primary plane of the configurable frame may comprise the plane of an opening (or aperture) of the configurable frame, the opening that may accommodate protrusion of or receive the in-wall device when installed.

In some embodiments, each of the walls may include a groove to receive a wedge between the wall and the contact on the terminal connector. The wedge, when inserted between the wall and the contact may apply a positive force on the contact towards the in-wall device to secure electrical contact between the contact and the power terminal on the in-wall device. In some embodiments, the force applied by the wedge is a second force or supplemental force applied on the terminal contact towards the power terminal of an in-wall wiring device. For instance, the terminal connector may include a slide portion, a spring portion, and a terminal portion. The spring portion of the terminal connector may apply or exert a first spring force towards the power terminal of the in-wall wiring device. In some embodiments, the wedge may press the terminal contact against the power terminal and the resiliency or elasticity of the terminal connector may apply the spring force towards the power terminal.

In some embodiments, during installation, the power support members may be adjusted to a position on the configurable frame that places terminal connectors in contact with the power terminals of the in-wall device. In some embodiments, the power support members and the configurable frame may include ratcheting features such as notches to snap the power support members into one or more positions.

The terminal connectors may be attached to the power support members at locations that positions the contacts on the terminal connectors in contact with the power terminals of the in-wall device. For embodiments in which the power support members comprise walls, perpendicular to the primary plane of the configurable frame, the configurable frame may be attached to the in-wall device; wedges may be inserted between the walls and the contacts of the terminal connectors to apply a force on the contacts towards the power terminals of the in-wall device; and a wall plate may be attached to the configurable frame with the wall plate connectors electrically contacting the power rails in the power support members of the configurable frame via exposed, hidden contacts in the configurable frame. In some embodiments, power rails on the wall plate (via a PCBA or wires) may interconnect corresponding power rails on the power support members of the configurable frame. In other embodiments, the power rails in the power support members of the configurable frame are connected to corresponding rails on another power support member via rails or wires on the configurable frame.

For other embodiments, the power support members may be located on notches or notches of ratcheting features that provide horizontal adjustability in the configurable frame that leave an opening (or aperture) in the configurable frame large enough to receive the in-wall device and the configurable frame may be attached to the in-wall device; one or more springs in the configurable frame may apply a force to the power support members towards the in-wall device to apply pressure on the terminal connectors to apply a force on the contacts of the terminal connectors towards the power terminals of the in-wall device; and a wall plate may be attached to the configurable frame with the wall plate connectors electrically contacting the power rails in the power support members of the configurable frame via exposed, hidden contacts in the configurable frame.

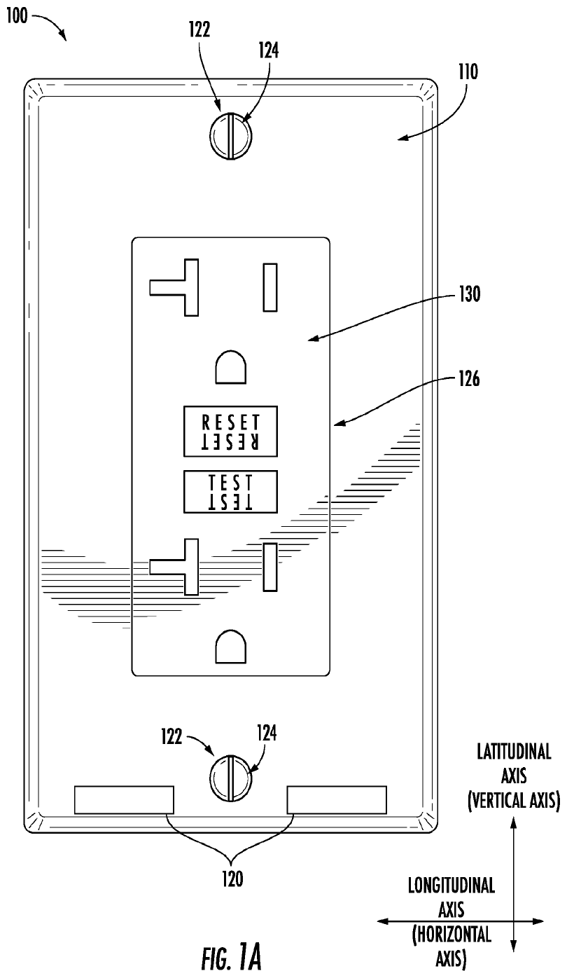

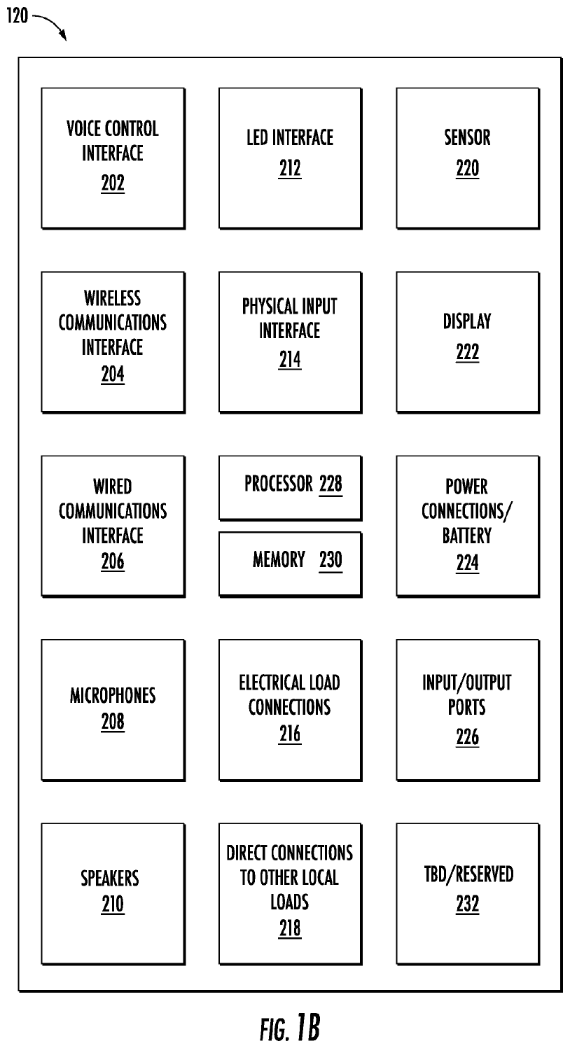

FIG. 1A illustrates a front view of an embodiment of a wall plate system 100. The wall plate system 100 may include one or more wall-plate electrical devices 120 coupled with a wall plate 110 such as light emitting diode (LED) lights, speaker(s), microphone(s), both speaker(s) and microphone(s) for, e.g., a smart speaker coupled with circuitry to implement a built in Alexa, Siri, Hey Google, Bixby, Cortana, etc. (digital voice assistants), chime(s) for doorbell or security alerts. touch controls devices, any combination thereof, and/or the like. In other embodiments, the one or more devices may comprise a printed circuit board assembly, a light socket, a universal serial bus connector, a button, a capacitive switch, a wireless network interface, an antenna, or a combination thereof.

The one or more devices may draw power from an in-wall wiring device 130 extending into a primary opening 126 (or aperture) of the wall plate 110. The wall plate 110 may further comprise openings 122 (or apertures) for screws 124 to mount the wall plate on an electrical junction box. In other embodiments, the wall plate 110 may comprise a screwless mount for attaching to an electrical junction box.

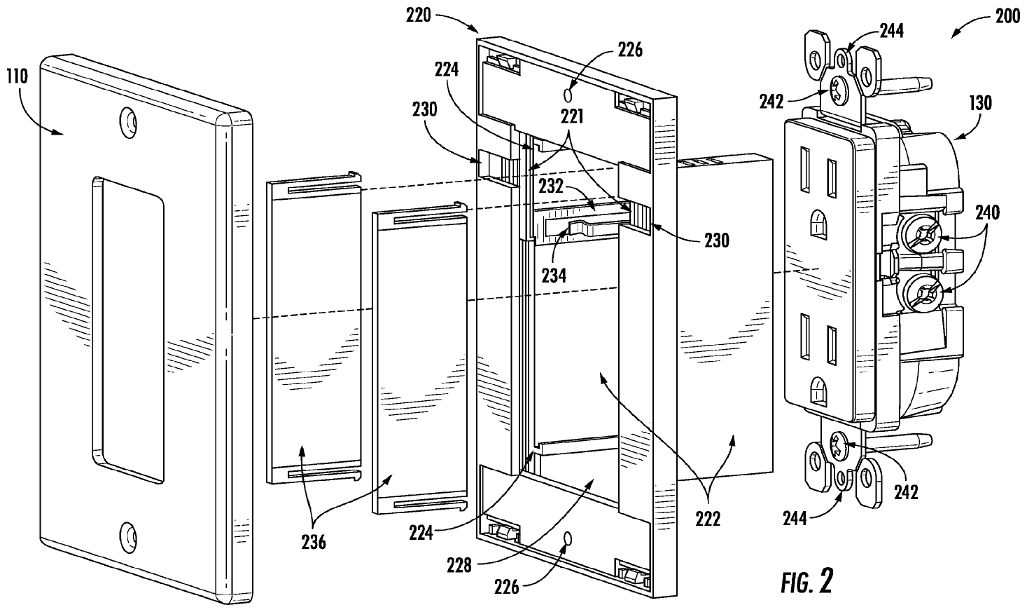

The in-wall wiring device 130 may comprise any device that fits within an electrical junction box and includes power terminals coupled with a power source. For instance, the in-wall device may comprise a light fixture, a lighting device, a load control device, an electrical outlet, a data hub or switch, a home automation device, a wireless networking device, a sensor, a nightlight, an audio outlet, a data outlet, a phone line outlet, a breaker, etc. In some embodiments, the in-wall wiring device 130 may include one or more or all the functional components described in FIG. 1B. For instance, the in-wall wiring device 130 may comprise all the functional components described in FIG. 1B and LED lights, a touch screen, or other user interactive component may couple with the wall plate 110 and/or the configurable frame 220. In some embodiments, some of the functional components depicted in FIG. 1B are integrated in the in-wall wiring device 130 and others of those functional components are coupled with the wall plate 110 and/or the configurable frame 220 (shown in FIG. 2).

While in-wall wiring devices 130, such as the in-wall electrical outlets, may be described and illustrated in some embodiments herein, embodiments are not so limited. The in-wall devices discussed herein can be any now known or hereafter developed in-wall device with power terminals connected to, e.g., wiring of a building such as a residential building, a commercial building, or an industrial building.

Note that some descriptions herein may refer to vertical adjustability/movement, horizontal adjustability/movement, longitudinal axis, latitudinal axis, and/or the like. FIG. 1A illustrates the horizontal axis, vertical axis, longitudinal axis, and latitudinal axis relative to the wall-plate system 100. As described herein, these axes are relative to the wall-plate system 100 regardless of the actual orientation of such wall-plate systems when installed.

Some embodiments implement one or more Institute of Electrical and Electronics Engineers (IEEE) standards. Such standards may include, for instance, the IEEE 802.11-2020, IEEE 802.11ah-2016, IEEE 802.11ai-2016, IEEE 802.15.4-2011, IEEE 802.11ay/D8.0, IEEE 802.11ba/D3.0, and IEEE 802.11ax/D3.3. Some embodiments implement the IEEE standards in accordance with a Wi-Fi Alliance specification such as the Wi-Fi Peer-to-Peer (P2P) technical specification version 1.7 published in 2017. Some embodiments implement other wireless communication protocols such as Bluetooth or Bluetooth Low Energy in accordance with, e.g., the Bluetooth Core Specification v5.0 published Dec. 6, 2016, Bluetooth Mesh, Near Field Communication, Zigbee, Z-wave, one or more cellular communication standards such as one or more 3rd Generation Partnership Project (3GPP), 3GPP Long Term Evolution (LTE), 3GPP LTE-Advanced (LTE-A), 4G LTE, and/or 5G New Radio (NR), technologies and/or standards, one or more infrared communication protocols, etc. Some embodiments implement a combination of one or more protocols of one or more of the standards and/or specifications. The embodiments are not limited to these standards.

FIG. 1B illustrates a block diagram of exemplary functional components of the one or more wall-plate electrical devices 120 of FIG. 1A. The one or more wall-plate electrical devices 120 may include devices individually coupled with the wall plate 110 and/or a configurable frame 220 (shown in FIG. 2) and/or coupled with one or more printed circuit boards (PCBs) attached to the wall plate 110 and/or the configurable frame 220. In some embodiments, the one or more wall-plate electrical devices 120 of FIG. 1A may couple with and extend or enhance functionality of the in-wall wiring device 130. For instance, one or more of the functional components shown in FIG. 1B may be part of the in-wall wiring device 130 and may couple with the remainder of the functional components coupled with the configurable frame 220 and/or the wall plate 110.

As shown, the one or more wall-plate electrical devices 120 may include a voice control interface 132. The voice control interface 132 may be used by the one or more wall-plate electrical devices 120 to receive voice commands or instructions from a user to control the one or more wall-plate electrical devices 120 and/or any device identified by the voice command or instruction. The voice control interface 132 may receive and determine voice commands and queries from the user. In various embodiments, the voice control interface 132 may interface with a remote cloud service platform (e.g., the My Leviton platform and/or the third-party cloud service platform) to interpret and respond to voice controls or queries from the user. In various embodiments, the voice control interface 132 may provide the capability to interpret and respond to voice controls or queries from the user. For purposes of discussion, descriptions of the voice control interface 132 herein may include local and/or remote voice processing and response capabilities (e.g., processing may be provided entirely locally at the one or more wall-plate electrical devices 120, processing may be provided remotely by a cloud service platform, and/or some combination thereof).

In one embodiment, the voice control interface 132 may listen for one or more “activation” words or signals. Upon hearing the activation word or signal, the voice control interface 132 will begin actively listening for a command or query and implement associated instructions. The voice control interface 132 may be a commercially-offered voice control interface such as, for example, Amazon Alexa, Google Assistant, Microsoft Cortana, or Samsung Bixby.

In various embodiments, the voice control interface 132 may be capable of distinguishing speakers-for example, the voice control interface 132 may be able to identify and distinguish different authorized users of the one or more wall-plate electrical devices 120. In various embodiments, the voice control interface 132 may determine which speaker to listen to and/or prioritize when multiple speakers are simultaneously verbally communicating with the one or more wall-plate electrical devices 120. For example, the voice control interface 132 may be implemented such that it listens and follows instructions from an adult rather than a child. That is, the voice control interface 132 may be capable of determining an identity of a particular person speaking to the one or more wall-plate electrical devices 120. The one or more wall-plate electrical devices 120 may identify and distinguish users and implement voice commands and/or respond to queries based on an established hierarchy of users.

In various embodiments, the voice control interface 132 can operate to follow or listen to the speaker who voiced the most recent command or query. For example, if two speakers issue a command to the one or more wall-plate electrical devices 120, then the most recently issued command will be followed and processed by the one or more wall-plate electrical devices 120. For example, in an embodiment where the one or more wall-plate electrical devices 120 is coupled to a remote switch, multiple speakers may simultaneously communicate with the one or more wall-plate electrical devices 120 and remote switch, respectively, the voice control interface 132 can be configured to follow or listen to the speaker who voiced the most recent command or query.

In various embodiments, the one or more wall-plate electrical devices 120 can provide presence detection such that the presence of a person within a building or room can be detected (e.g., based on voice detection, motion detection, learned activity processing, etc.). Lighting control can then be based on any determined presence detection. In various embodiments, the one or more wall-plate electrical devices 120 can provide various levels of access control, depending upon the person interacting with the one or more wall-plate electrical devices 120. For example, users of the one or more wall-plate electrical devices 120 can be categorized, with different categories providing relatively increased or decreased control capabilities for the one or more wall-plate electrical devices 120 and any device coupled thereto. In an example, an unknown or unverified user of the one or more wall-plate electrical devices 120 may only be able to control local lighting devices while being unable to control any remotely coupled device. In contrast, an identified and authenticated “administrative” user of the one or more wall-plate electrical devices 120 may be granted access or ability to control any device connected to the one or more wall-plate electrical devices 120 and can even reconfigure the one or more wall-plate electrical devices 120.

The voice control interface 132 may understand and process voice control commands such that any of the other devices or services depicted in FIG. 1A may be accessed or controlled. For example, the voice control interface 132 may relay received voice commands to control local devices (e.g., to turn ON/OFF a lighting device or adjust a setting for thermostat device). As a further example, the voice control interface 132 may relay received voice commands to control remote devices (e.g., to turn ON/OFF a remote lighting device or adjust a setting for a remote thermostat device). The voice control interface 132 may follow voice control commands to provide links to the My Leviton platform 108 or the third-party cloud service platform 110.

The one or more wall-plate electrical devices 120 may include a wireless communications interface 134. The wireless communications interface 134 may include the wireless communication antenna or a connection for an antenna integrated with the wall plate 110 depicted in FIG. 1A or the configurable frame 220 depicted in FIG. 2. The wireless communications interface 134 may provide interfaces for communicating with any local or remote device or network through any wireless communication technology.

The one or more wall-plate electrical devices 120 may include a wired communications interface 136. The wired communications interface 136 may include the wired communications connector such as a female connector to receive, e.g., an RJ-45 connector or male connector to plug into a female connector. The wired communications interface 136 may provide interfaces for communicating with any local or remote device or network through any wired communication technology.

The one or more wall-plate electrical devices 120 may include one or more microphones 138. The microphone 138 may detect audible commands and queries from the user. The microphone 138 may provide received audio information to the voice control interface 132 for processing. The one or more wall-plate electrical devices 120 may further include one or more speakers 140. The speaker 140 may output audio information to the user. The audio information may include synthesized voices from the voice control interface 132 and other audible information such as music or an alarm.

The one or more wall-plate electrical devices 120 may further include a light emitting diode (LED) interface 142. The LED interface 142 may include one or more LEDs. The LED interface 142 may provide and adjust a visual display based on an operational state of the one or more wall-plate electrical devices 120 and/or any service platform, or voice service coupled thereto (e.g., to indicate processing of a command, powering up, powering off, etc.). The LED interface 142 may provide a way for communicating information to the user visually by adjusting the visual state of any LEDs coupled thereto.

The one or more wall-plate electrical devices 120 may further include a physical input interface 144 for interfacing with one or more physical inputs that may be manipulated by the user. The physical input interface 144 may include or may be coupled to a variety of inputs including a keyboard, push buttons, or slides. The physical input interface 144 may provide a way for the user to communicate information to the one or more wall-plate electrical devices 120, for example, to adjust operation of the one or more wall-plate electrical devices 120.

The one or more wall-plate electrical devices 120 may also include an electrical load connection 146 providing electrical connectivity to a load controlled by the one or more wall-plate electrical devices 120. Coupled loads may include any type of load such as, for example, a lighting load including, for example, an incandescent bulb, an LED bulb, a CFL bulb, an EVL, a Resistive, Halogen, Fluorescent, etc., an inductive load, ½ HP motor, etc.

The one or more wall-plate electrical devices 120 may include additional connections to other local loads 148. The connections to other local loads 148 enables the one or more wall-plate electrical devices 120 to directly control other local loads including, for example, other local lighting devices. Accordingly, the additional connections to other local loads 148 allows the user to adjust operation of other nearby lighting devices without requiring communications through other wired or wireless communication channels (e.g., through Wi-Fi or cloud based services or components).

The one or more wall-plate electrical devices 120 may also include a sensor 150. The sensor 150 may be physically attached to and part of the one or more wall-plate electrical devices 120 or may be coupled to the one or more wall-plate electrical devices 120 by a wired or wireless communications connection (e.g., remote to the one or more wall-plate electrical devices 120). The sensor 150 may be any type of sensor including a temperature sensor, humidity sensor, light sensor, motion sensor, occupancy sensor, smoke detector, gas sensor, etc. The sensor 150 may detect conditions or physical attributes of a localized space surrounding the sensor 150 and may provide an indication of the same to the one or more wall-plate electrical devices 120. Received information from the sensor 150 may be used to control or adjust operation of any of the one or more wall-plate electrical devices 120, for example, those depicted in FIG. 1A. Received information from the sensor 150 may be relayed to the user (e.g., through an audible signal from the one or more wall-plate electrical devices 120, through a visible signal from the one or more wall-plate electrical devices 120, by providing information to an app on a mobile device, etc.) or to any other device.

The one or more wall-plate electrical devices 120 may also include a display 152. The display 152 may include a visual display that may render visual information and a display controller for controlling the rendering of any visual information. The visual information may be any graphical or textual information. The display 152 may include a touchscreen or a touch-sensitive display. Accordingly, the display 152 may provide visual information to the user and/or may receive input from the user. The display 152 can be part of the LED interface 142 or can be separate therefrom. In various embodiments, the display 152 and/or the LED interface 142 can include an LCD interface.

The one or more wall-plate electrical devices 120 may also include a power source 154. The power source 154 may include electrical power connections and/or a battery 154. The power source 154 may provide power to any of the constituent functional components of the one or more wall-plate electrical devices 120 depicted in FIG. 1B. In many embodiments, the power source 154 may be coupled to power terminals 240 of the in-wall-wiring device 130 of the physical space in which the one or more wall-plate electrical devices 120 operates and may provide battery backup during power failures or outages.

In one embodiment, the one or more wall-plate electrical devices 120 may provide hard-wired multi-way applications that may interact with a remote control (e.g., a wireless digital remote control).

The one or more wall-plate electrical devices 120 may also include one or more input/output ports 156. The input/output ports 156 may include any number and type of input and/or output ports including USB, HDMI, A/V, and a speaker/headphone jack. The input/output ports 156 provide alternative manners for communicating with the constituent functional components of the one or more wall-plate electrical devices 120 depicted in FIG. 1B or provide alternative ways of providing outputs from any of the same.

The one or more wall-plate electrical devices 120 may further include a processor circuit 158 and an associated memory component 160. The memory component 160 may store one or more programs for execution by the processor circuit 158 to implement one or more functions or features of the one or more wall-plate electrical devices 120. Further, the processor circuit 158 may maintain a real-time clock for the one or more wall-plate electrical devices 120. The processor circuit 158 may be implemented using any processor or logic device. The memory component 160 can be implemented using any machine-readable or computer-readable media capable of storing data, including both volatile and non-volatile memory, and may reside internal or external to the one or more wall-plate electrical devices 120.

The processor circuit 158 may implement the functionalities of any of the components depicted in FIG. 1B or may control or adjust operation of any of the depicted components. Each component depicted in FIG. 1B may be coupled to the processor circuit 158 as well as any other depicted component. The depicted components may be implemented in hardware or software as appropriate, or any combination thereof.

The one or more wall-plate electrical devices 120 may further include one or more remote processor circuits and/or one or more remote databases 162. In various embodiments, the remote processor and database 162 may be located within the same physical environment as the one or more wall-plate electrical devices 120 (e.g., coupled to the one or more wall-plate electrical devices 120 and located within a basement or storage area of a home or office) or may be located in a separate, physically distinct environment. The remote processor and/or database 162 can provide supplemental computing power and extended memory to enhance the performance of the one or more wall-plate electrical devices 120 without affecting the relatively small size and form factor of the one or more wall-plate electrical devices 120.

The one or more wall-plate electrical devices 120 may provide one or more of the following exemplary features, functions, and capabilities based on the constituent functional components depicted in FIG. 1B in conjunction with the devices, services, network architecture, and other components provided in the operating environment.

For example, in one embodiment, the one or more wall-plate electrical devices 120 may include a voice control interface to integrate IoT and/or smart functionality into everyday activities. In this manner, the one or more wall-plate electrical devices 120 may provide a seamless and integrated architectural solution for providing voice control and/or access to, for example, local and remote devices, the My Leviton platform, the Internet, and third-party platform providers such as, for example, Amazon to provide voice control for a residence, office, retail space, etc.

Additional, and/or alternatively, the one or more wall-plate electrical devices 120 enables connection and/or control of directly connected local and/or remote lighting devices, or through, for example, the My Leviton platform (e.g., either directly to the My Leviton platform or through a third-party cloud service platform). The load control device may enable monitoring and control operation of local and remote lighting devices through received voice commands and/or physical inputs such as, for example, manual actuation of one or more buttons. In addition, the load control device may enable a user to trigger automation activities and lighting scenes with respect to the local or remote lighting devices.

Additional, and/or alternatively, the one or more wall-plate electrical devices 120 may recognize and implement voice commands and/or respond to queries by linking a user to any local or remote components and/or devices.

FIG. 2 illustrates a side angle view from the front of components of an embodiment of a wall plate system 200 such as the wall plate system 100 depicted in FIG. 1A. Specifically, FIG. 2 illustrates the single-gang wall plate 110, a configurable frame 220, and an in-wall wiring device 130. The configurable frame 220 includes one or more power support members 221 parallel to the primary opening 228 (or aperture) of the configurable frame 220 to receive the in-wall wiring device 130. In the present embodiment, the configurable frame 220 includes two walls 222 coupled with the configurable frame 220 via the power support members 221. A terminal connector 232 is coupled with configurable frame 220 and the wall 222. While not shown, the configurable frame 220 may include two or more terminal connectors 232 and, in the present embodiment, a second terminal connector 232 may be coupled with the wall 222 opposite the terminal connector 232 shown in FIG. 2 on the opposite side of the face of the wall 222 shown such that the terminal connector 232 faces toward the opening 228 of the configurable frame 220.

The terminal connectors 232 can slide up and down the walls 222 to align contacts 234 of the terminal connectors 232 with one of the power terminals 240 on the sides of the in-wall wiring device 130. The configurable frame 220 also comprises openings 230 (or apertures) to remove and/or insert the terminal connectors on either or both of the power support members 221 and walls 222. In some embodiments, the terminal connectors 232 may include a spring portion 233 interconnecting the contacts 234 with a slide portion 231 of the terminal connectors 232.

The walls 222 may comprise guides 224 at, e.g., the top and bottom of the wall 222 facing the opening for the in-wall wiring device 130. The guides 224 may receive one or more wedges 236. In other embodiments, the walls 222 may be part of the power support members 221. The walls 222 may provide a physical “stop” to any outward motion of the terminal connectors 232 and against which the spring force of the spring portion 233 of terminal connector, the force of the wedge 236 on the terminal contact 234, and the force of the power terminal 240 of the in-wall wiring device 130 against the terminal contact 234 are balanced.

After aligning electrically conductive contacts 234 of the terminal connectors 234 with corresponding power terminals 240 on the in-wall wiring device 130 and inserting the power support members of the configurable frame 220 into an electrical junction box (not shown) on which the in-wall wiring device is mounted, the wedges 236 may be slid or inserted in the guides 224 of the walls 222 to position the wedges 224 between the electrically conductive contacts 234 of the terminal connectors 232 and the walls 222 to apply force to the electrically conductive contacts towards the power terminals 240.

Note that the power terminals 240 shown may both connect to a power phase wire and that two additional power terminals may reside on the opposite side of the in-wall wiring device 130 that connect to a neutral wire. In such embodiments, one of the terminal connectors 234 such as the one shown in FIG. 2 should be aligned with, e.g., the top power terminal on the neutral side and one of the terminal connectors 232 should be aligned with the top power terminal on the power phase side. While the terminal connectors 232 can be aligned with the bottom power terminals 240, in some embodiments, the bottom power terminals 240 (the bottom screw shown) can be disconnected from the top power terminal 240 (top screw shown) for purposes of, e.g., switching the power to the bottom electrical receptacle on or off via a switch. On the other hand, if desirable to turn on or off a light device coupled with the wall plate 110 via such a switch, the terminal connectors 232 may both be aligned with the lower of the two power terminals 240.

In other embodiments, the in-wall wiring device 130 may not include two power terminals on two different sides of the in-wall wiring device 130. For instance, the in-wall wiring device 130 may only comprise a single power terminal on each side of the in-wall wiring device 130 or may comprise two or more power terminals on only one side of the in-wall wiring device 130.

The in-wall wiring device 130 may include a mounting hole with a mounting screw 242 coupling the in-wall device with an electrical junction box (not shown). The in-wall wiring device 130 may also include mounting holes 244 for mounting the configurable frame 220 to the in-wall wiring device 130 and, in some embodiments, for also mounting the wall plate 110 to the in-wall wiring device 130.

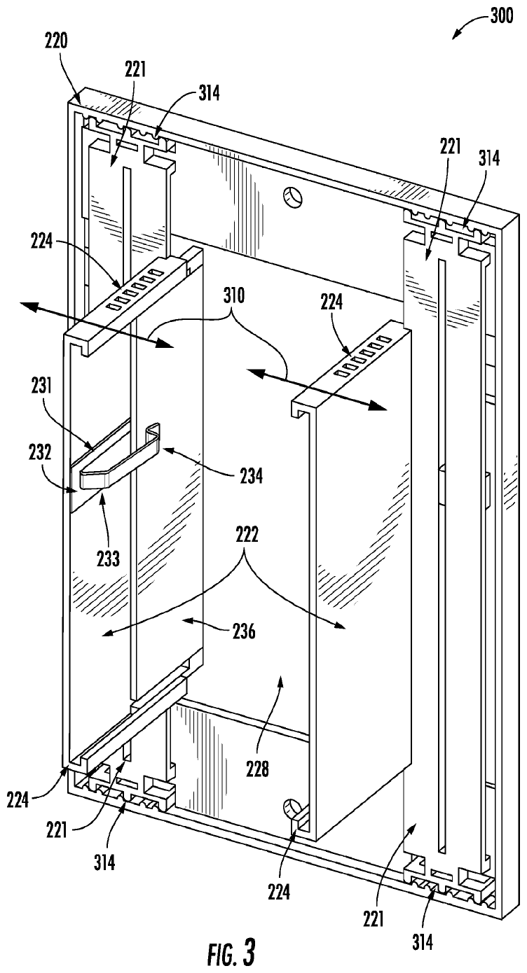

FIG. 3 illustrates a side angle view from the back of the configurable frame 220 of an embodiment of a wall plate system 300 such as the wall plate system 100 depicted in FIG. 1A. The configurable frame 220 comprises two or more power support members 221. In the present embodiment, the configurable frame 220 comprises two power support members 221 on the right and left sides of the primary opening 228. In many embodiments, the configurable frame 220 comprises ratcheting features that allow horizontal adjustability of the power support members 221. The ratcheting features may include notches 314 to snap the power support members 221 into one or more positions. In many embodiments, the notches 314 define two or more positions that define the distance between the walls 222 and also the distance between the terminal connectors 232. Movements 310 illustrate movement of the walls 222 to the left or right with respect to the configurable frame 220.

Once the power support members 221 are positioned for connection of terminal connectors 232 to power terminals 240 of the in-wall wiring device 130, and the terminal connectors 232 are aligned vertically with the power terminals of the in-wall wiring device 130, the walls 222 may be inserted into the electrical junction box on which the in-wall wiring device 130 is mounted and the wedges 236 may be inserted via the guides 224 of the walls 222 between the electrically conductive contacts 234 of the terminal connectors 232 and the walls 222 to apply force to the electrically conductive contacts 234 towards the power terminals 240 of the in-wall wiring device 130. Note that the force applied to the electrically conductive contacts 234 may be in addition to the force applied by the power support members 221 to position the contacts 234 of terminal connectors 232 on the power terminals 240. In other embodiments, the wedges 236 may apply force to the contacts 234 to connect the contacts 234 with the power terminals 240. The spring portion 233 may apply a spring force towards the wedge 236 after insertion of the wedge 236 and may apply a spring force towards the power terminal 240 after insertion about the in-wall wiring device 130.

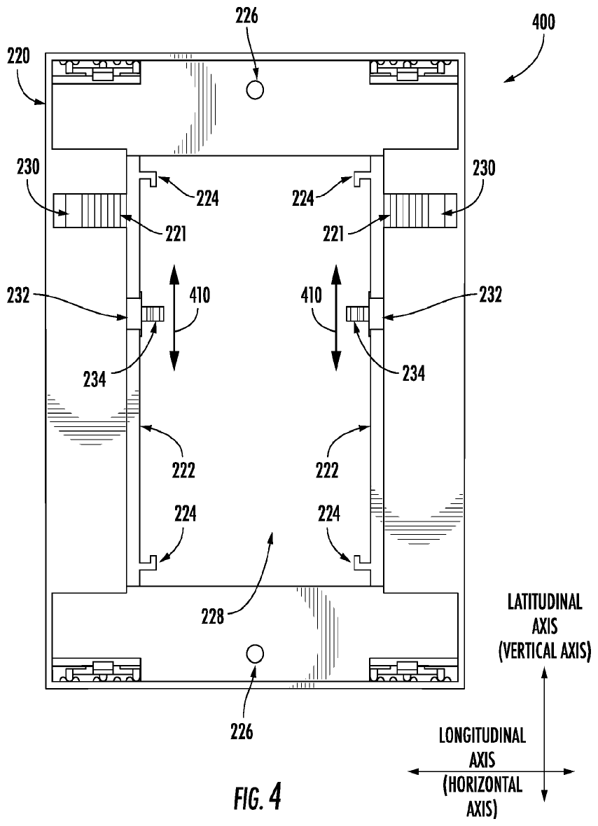

FIG. 4 illustrates a front view of a configurable frame 220 of an embodiment of a wall plate system 400 such as the wall plate system 100 depicted in FIG. 1A. The configurable frame 220 may include a mounting hole 226 to mount the configurable frame 220 between the wall plate 100 and the in-wall wiring device 130, openings (or apertures) to insert and/or remove the terminal connectors 232 and connect the terminal connectors to the power support members 221, and walls 222 with guides 224. Note that this view shows the terminal connectors 232 on both sides (right and left) of the primary opening 228 of the configurable frame 220 with the terminal connectors 232 aligned for power terminals 240 of the in-wall wiring device. Movement 410 illustrates the ability to slide the terminal connectors 232 up or down the walls 222 to locate the electrically conductive contacts 234 of the terminal connectors 232 in a position to connect with the power terminals 240 when the configurable frame is mounted on the in-wall wiring device 130.

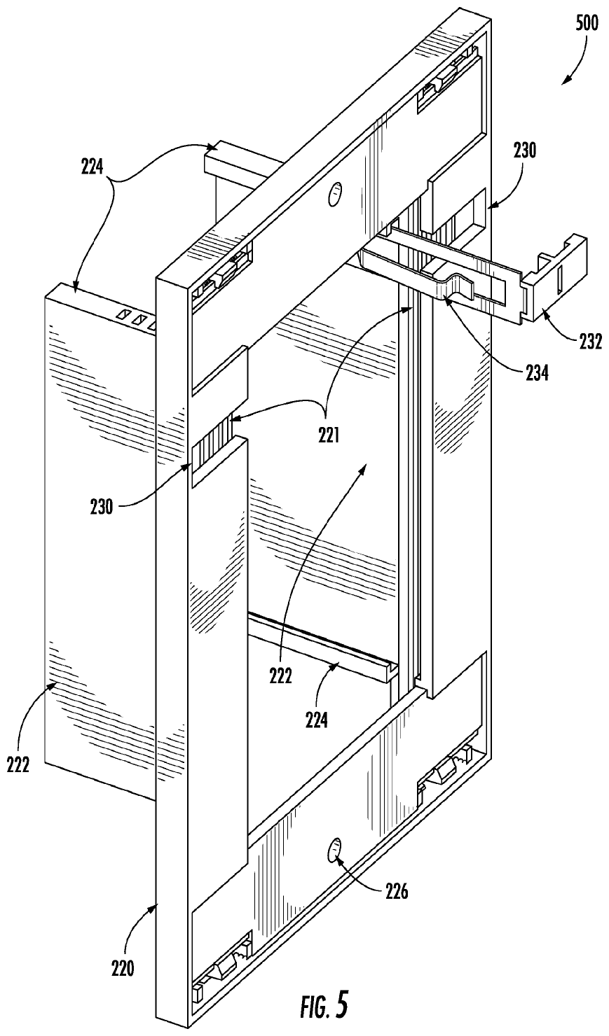

FIG. 5 illustrates a side angle view from the front of a configurable frame 220 of an embodiment of a wall plate system 500 such as the wall plate system 100 depicted in FIG. 1A. The configurable frame 220 comprises openings 230 (or apertures) for insertion or removal of terminal connectors 232 onto power support members 221 and walls 222. The walls 222 may include guides 224 for insertion of wedges between the terminal connectors 232 and the electrically conductive contacts 234 of the terminal connectors 232.

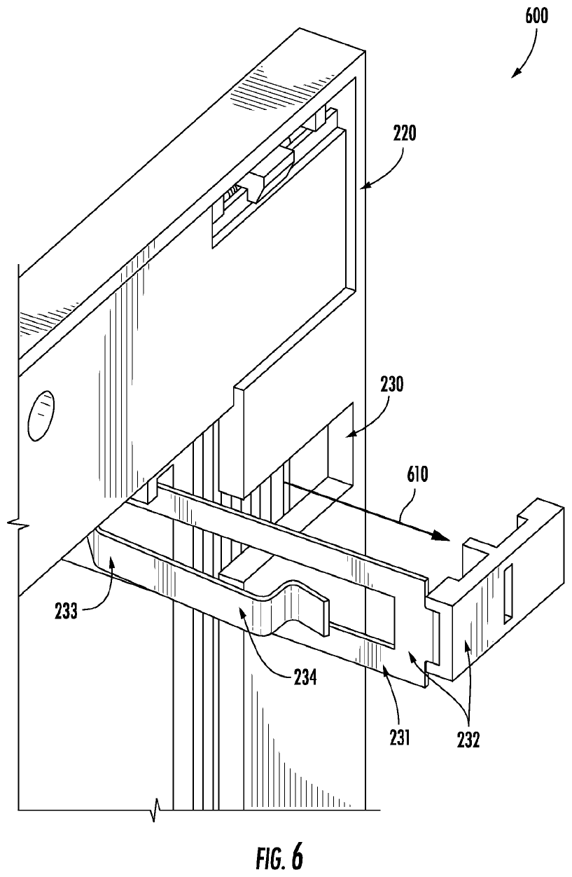

FIG. 6 illustrates another side angle view from the front of a configurable frame 220 of an embodiment of a wall plate system 600 such as the wall plate system 100 depicted in FIG. 1A. The view shows an exploded view of the terminal connector 232 at the opening 230 along with movement 610 to illustrate removal of the terminal connector 232 from the configurable frame 220. The view also shows the slide portion 231 of the terminal connector 232 electrically coupled with the terminal contact 234 via the spring portion 233 of the terminal connector 232. The spring portion 233 may apply a spring force towards the power terminal 240 of the in-wall device 130.

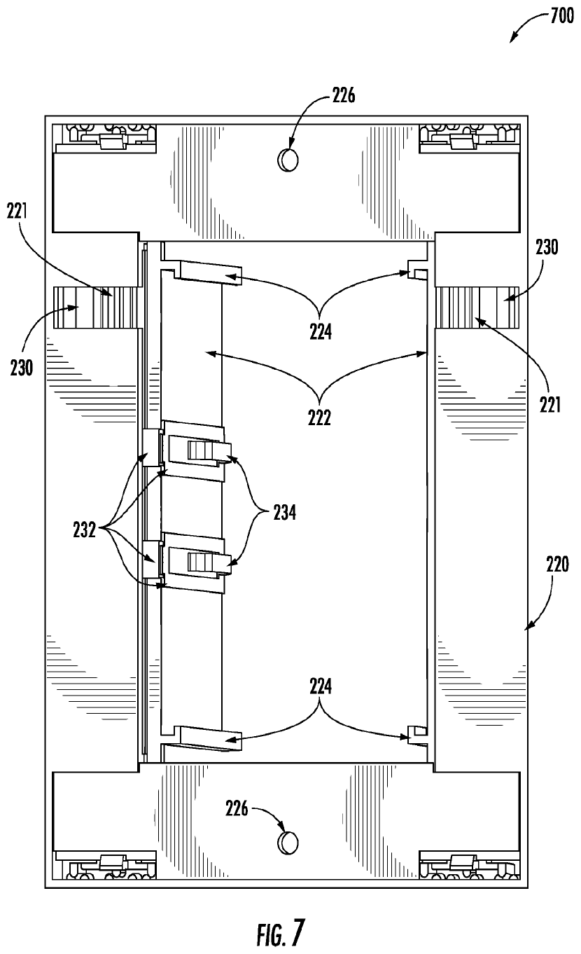

FIG. 7 illustrates another side angle view from the front of a configurable frame 220 of an embodiment of a wall plate system 700 such as the wall plate system 100 depicted in FIG. 1A. The configurable frame 220 includes openings 230, the power support members 221 seen through the openings, walls 222 with guides 224 and two terminal connectors installed on one side coupled with one of the walls 222. Note that the two terminal connectors 232 can be installed on either wall or one of the terminal connectors 232 can be installed on a first one of the walls 221 and the second one of the terminal connectors 232 can be installed on a second one of the walls 221. Other embodiments may comprise more than two terminal connectors.

Note that each of the terminal connectors 232 may be configured to electrically connect with one of the power rails in the power support members 221 regardless of the wall 222 with which the terminal connector 232 is coupled.

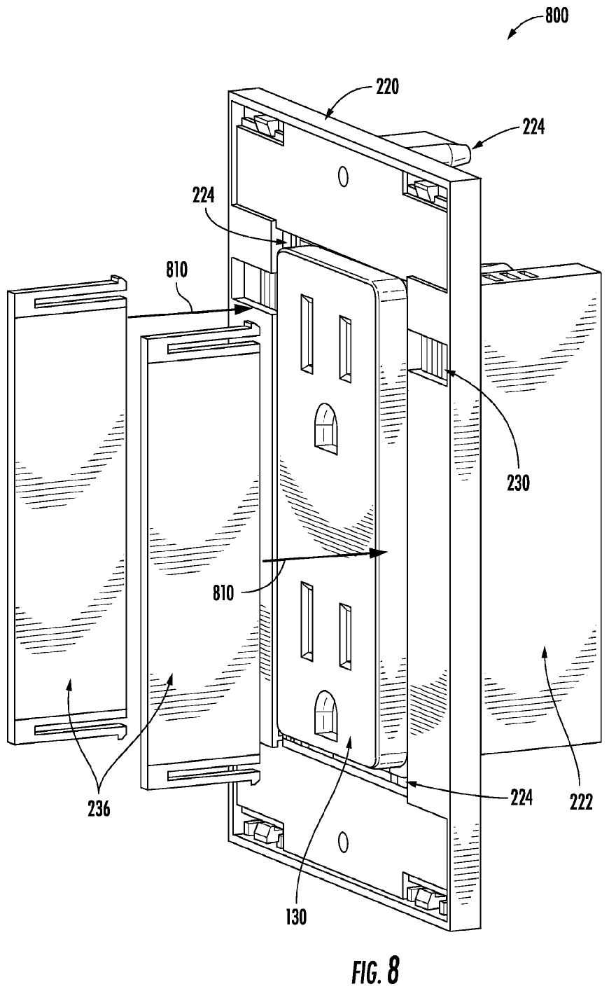

FIG. 8 illustrates another side angle view from the front of a configurable frame 220 of an embodiment of a wall plate system 800 such as the wall plate system 100 depicted in FIG. 1A. The view shows the configurable frame 220 attached to the in-wall wiring device 130 prior to installation of the wedges 236. After the terminal connectors 232 are aligned with the power terminals of the in-wall wiring device 130 and the configurable frame 220 is attached to the in-wall wiring device 130, the wedges 236 may be inserted 810 in the guides 224 of the walls 221 and slid into position (slid into the guides 224 until the back of the wedges 236 are at least flush with the configurable frame 220. In many embodiments, the wedges 236 will not protrude from the configurable frame 220 when correctly positioned.

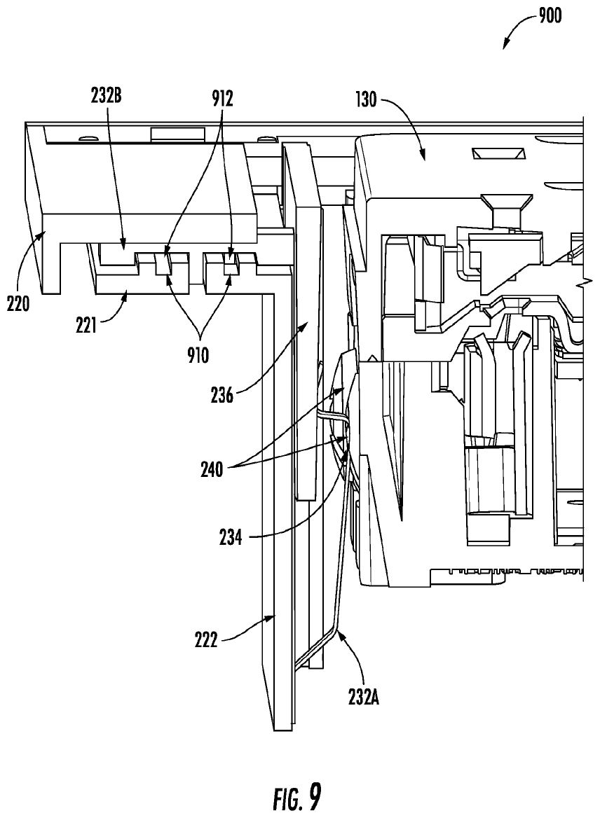

FIG. 9 illustrates a cross-sectional view from the top of a configurable frame 220 and in-wall wiring device 130 of an embodiment of a wall plate system 900 such as the wall plate system 100 depicted in FIG. 1A. In this view, the configurable frame 220 is mounted on the in-wall wiring device 130. The terminal connector 232 is positioned to place the electrically conductive contact 234 in contact with the upper power terminal 240 of the two illustrated power terminals (shown as screw heads) 240. The wedge wall 222 maintains the position of the terminal connector 232 and the wedge 236 is inserted between the wall 222 and the electrically conductive contact 234, applying a force on the electrically conductive contact 234 to maintain an electrical connection between the electrically conductive contact 234 and the upper power terminal 240.

The configurable frame 220 also illustrates a cross section of the power support members 221 with grooves 910 that include conductive power rails 912. Each terminal connector 232 may interconnect one of the conductive power rails 912 with the electrically conductive contact 234.

In some embodiments, the terminal connector 232 includes an electrically conductive portion 232A and an electrically insulative portion 232B. Note that, in the present embodiments, both the electrically insulative portion 232B of the terminal connector 232 and an electrically insulative power support member 221 include electrically insulative barriers between the rails 912 on the power support member 221.

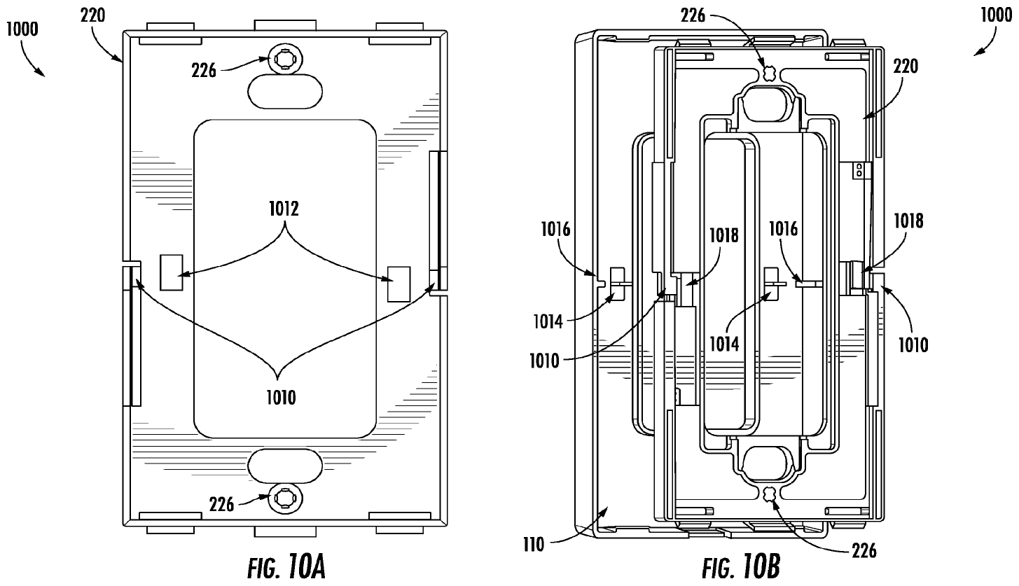

FIGS. 10A-B illustrates a view from the back of a configurable frame 220 and an angled back side view of an embodiment of a wall plate system 1000 such as the wall plate system 100 depicted in FIGS. 1A, 2, and 12. FIG. 10A and FIG. 10B illustrate one example of interconnections between the configurable frame 220 and the wall plate 110 to electrically connect power from the power terminals 240 of an in-wall wiring device 130 with wall plate contacts 1014 (generally referred to as wall plate connectors) to supply power to one or more devices on the wall plate 110.

When the wall plate 110 is attached to the configurable frame 220, the protrusion 1016 on both sides of the wall plate 110 press on a flexible component 1010 on both sides of the configurable frame 220, causing the flexible components 1012 to expose the contacts 1018 of the configurable frame 220 via the openings 1012 (or apertures) in the configurable frame 220. The contacts 1018 may comprise an electrically conductive material such as a copper or copper alloy and, in some embodiments, also an electrically insulative material. The contacts 1018 may be connected to one or more rails in the power support members 221 of the configurable frame 220.

The wall plate 110 may comprise wall plate contacts 1014 to couple with the contacts 1018 of the configurable frame 220 to electrically connect the wall plate contacts 1014 with the power terminals 240 of the in-wall wiring device 130. In some embodiments, the wall plate contacts include a protrusion (as shown) such as a pogo pin, a spring-loaded pin, a stab, and/or the like to electrically connect with the contacts 1018.

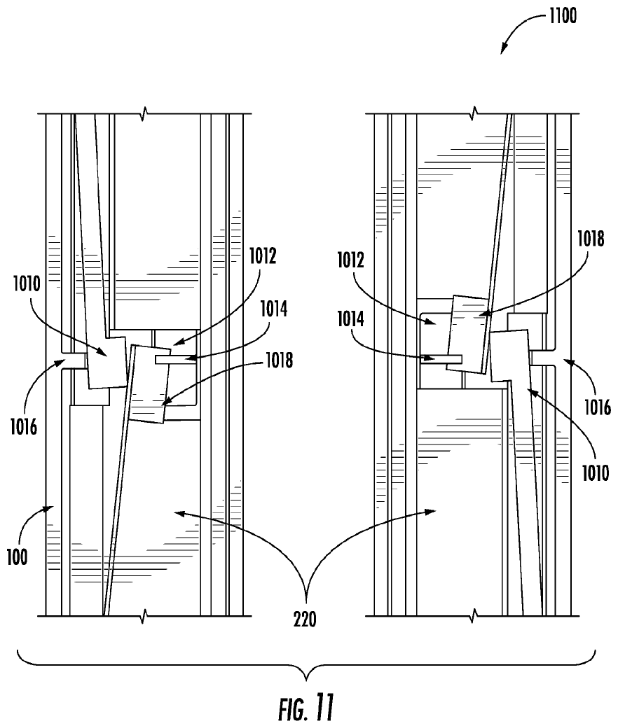

FIG. 11 illustrates an embodiment of another view of a wall plate 110 attached to a configurable frame 220 to partially or fully expose hidden contacts 1018 of an embodiment of a wall plate system 1100 such as the wall plate system 100 depicted in FIGS. 1A, 2, and 12. The protrusions 1016 of the wall plate 110 press on the flexible components 1010 of the configurable frame 220 and the flexible components 1010 press on the contacts 1018 to expose the contacts 1018 through the openings 1012. Protrusions of the wall plate contacts 1014 electrically connect with the contacts 1018 of the configurable frame 220.

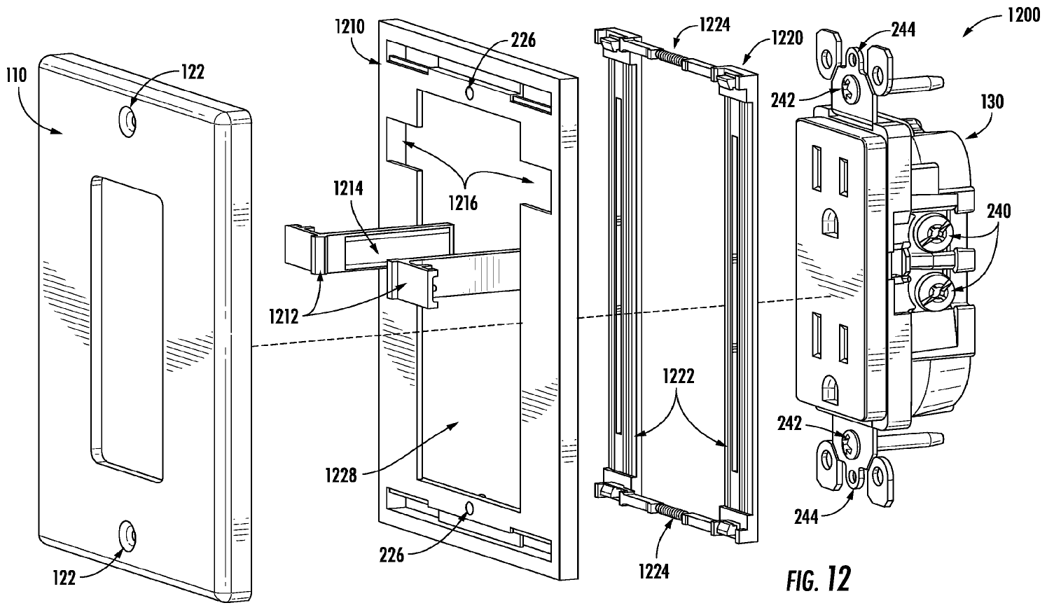

FIG. 12 illustrates a side angle view from the front of components of an alternative embodiment of a wall plate system 1200 such as the wall plate system 100 depicted in FIG. 1A. The wall plate 110 may include mounting holes 122 for attaching the wall plate 110 and configurable frame 1210 to the in-wall wiring device 130.

The configurable frame 1210 may comprise mounting holes 226, openings 1216 (or apertures) for insertion and/or removal of terminal connectors 1212, and an opening 1228 (or aperture) to receive the in-wall wiring device 130. The terminal connectors 1212 may comprise electrically conductive contacts 1214 to couple with the power terminals 240.

The configurable frame 1210 may also include an adjustable attachment 1220. The adjustable attachment may couple power support members 1222 with one or more springs 1224 to apply an inward force on the power support members 1222 towards each other. The inward force, when the power support members 1222 are coupled with the terminal connectors 1212 place an inward force on the terminal connectors 1212, which, as a result, apply an inward force on the contacts 1214 towards the power terminals 240 of the in-wall wiring device 130.

The in-wall wiring device 130 may comprise mounting holes 244 for the wall plate and/or the configurable frame 1210, the mounting holes 226 for the configurable frame 1210, and the screw mounts 242 may attach the in-wall wiring device 130 with an electrical junction box (not shown).

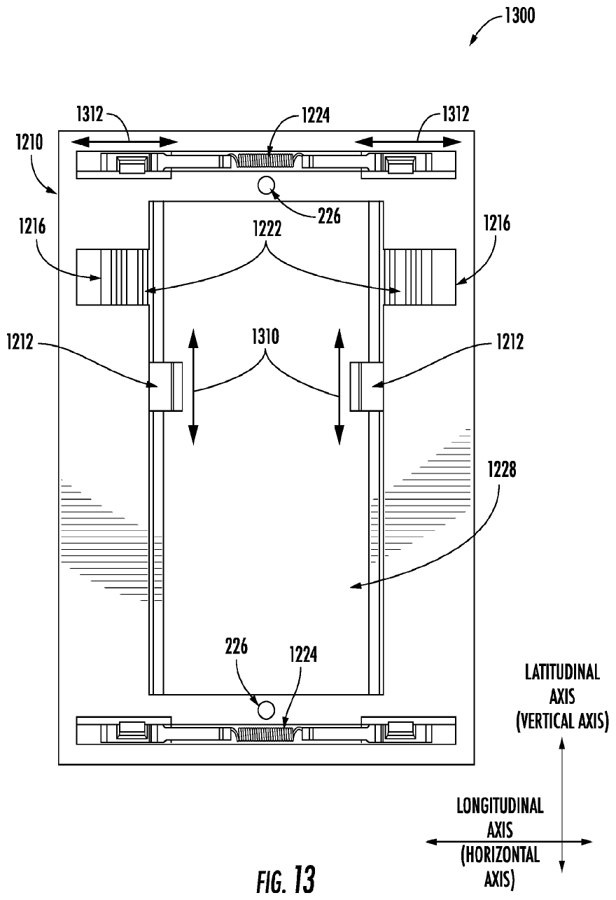

FIG. 13 illustrates a front view of a configurable frame 1210 of an alternative embodiment of a wall plate system 1300 such as the wall plate system 100 depicted in FIG. 1A. The configurable frame 1210 may comprise springs 1224 to apply force to the terminal connectors 1212 towards power terminals 240 (shown in FIG. 12) of an in-wall wiring device 130. The terminals connectors 1212 can slide 1310 up or down the power support members 1222 to align the terminal connectors with the power terminals 240. In some embodiments, the power support members 1222 and the terminal connectors 1212 interact to snap the terminal connectors 1212 at multiple positions along the length of the power support members 1222. For instance, the power support members 1222 may include ratcheting features for horizontal adjustability. Such ratcheting features may include notches that provide a force to maintain a current position of the terminal connectors 1212. In some embodiments, the notches may be uniformly distributed along at least a portion of the power support members 1222. In other embodiments, the notches may be located at known positions for the terminal connectors 1212 to align with power terminals 240 (shown in FIG. 12) of an in-wall wiring devices 130.

The configurable frame 1210 may also comprise openings 1216 to insert and/or remove terminal connectors 1212 and one or more springs 1224 that facilitate horizontal movement 1312 of the power support members 1222 to apply a force between the terminal connectors 1212 and the power terminals 240 of an in-wall wiring devices 130. In some embodiments, the notches in the adjustable attachment 1220 and/or another part of the configurable frame may add a resistance to movement of the power support members 1222 outward, away from the in-wall wiring device 130. In further embodiments, the configurable frame 1210 may comprise one or more stops for the one or more power support members 1222 to stop narrowing of the opening 1228 in the configurable frame 1210 for the in-wall wiring device 130 at a minimum opening (or aperture) width, a maximum opening (or aperture) width, or a combination thereof.

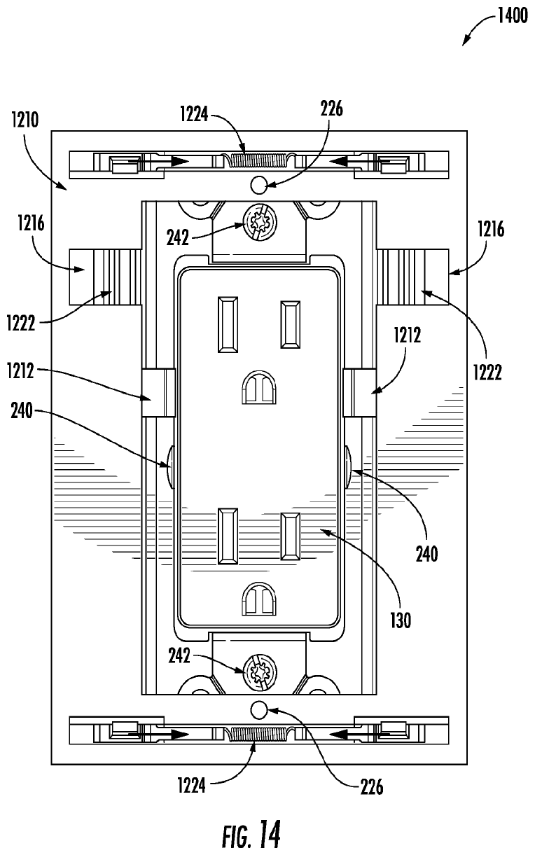

FIG. 14 illustrates another front view of a configurable frame 1210 coupled with an in-wall wiring device 130 of an alternative embodiment of a wall plate system 1400 such as the wall plate system 100 depicted in FIG. 1A. The terminal connectors 1212 are coupled with the upper power terminals 240 (behind the terminal connectors 1212. The lower power terminals 240 can be seen in the illustration and are not directly connected with the terminal connectors 1212.

The springs 1224 may apply a force on the power support members 1222 towards the in-wall wiring device 130 and the power support members 1222 may apply a corresponding force on the terminal connectors 1212 towards the in-wall wiring device 130. FIG. 14 also shows the openings 1216 to insert or remove the terminal connectors 1212 from the configurable frame 1210.

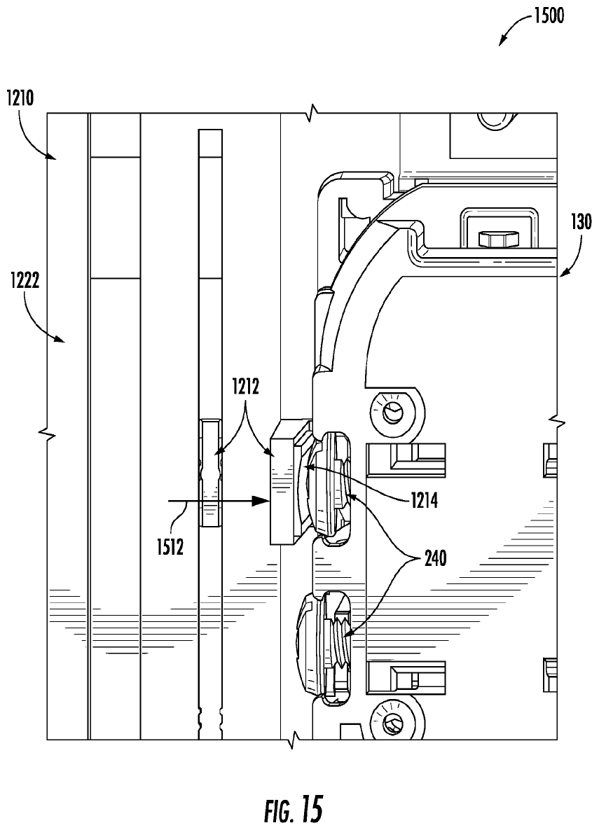

FIG. 15 illustrates a back view of a configurable frame 1210 with an in-wall device 130 of an alternative embodiment of a wall plate system 1500 such as the wall plate system 100 depicted in FIG. 1A. The view is an exploded view showing the electrical connection between the electrically conductive contact 1214 of the terminal connector 1212 on the upper power terminal 240. The power support member 1222 applies a force 1512 on the terminal connector 1212 towards the in-wall wiring device 130.

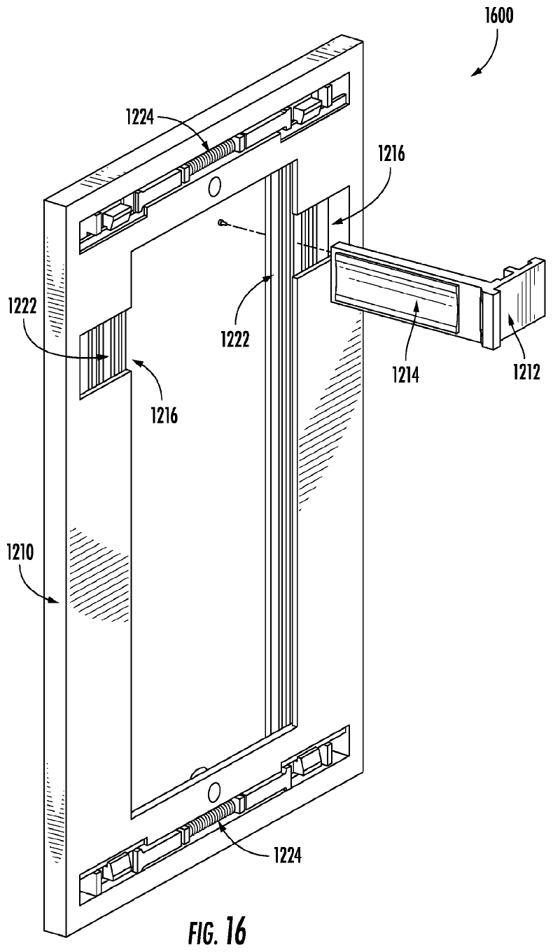

FIG. 16 illustrates a side angle view from the front of a configurable frame 1210 of an alternative embodiment of a wall plate system 1600 such as the wall plate system 100 depicted in FIG. 1A. The configurable frame 1210 includes two springs 1224 coupled with the power support members 1222 and openings 1216 to insert and/or remove the terminal connectors 1212.

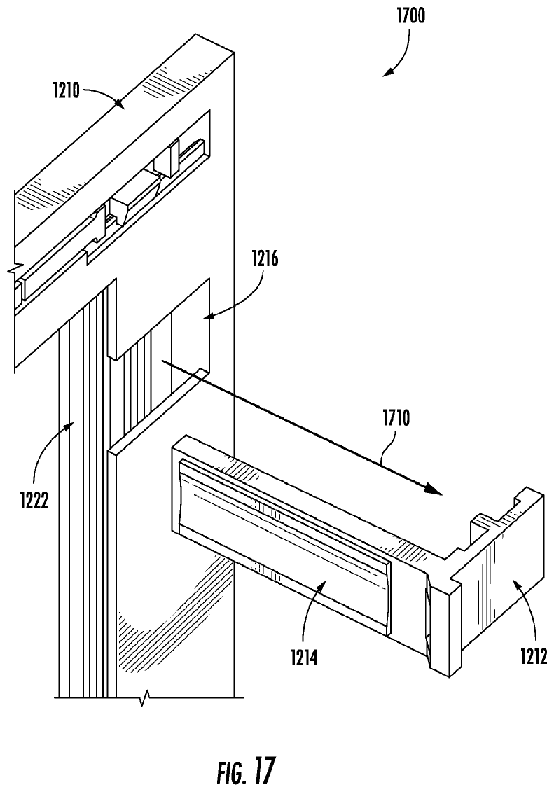

FIG. 17 illustrates another side angle view from the front of a configurable frame 220 of an alternative embodiment of a wall plate system 1700 such as the wall plate system 100 depicted in FIG. 1A. The view is an exploded view to illustrate the removal 1710 of the terminal connector 1212 from the opening 1216 of the configurable frame 1210.

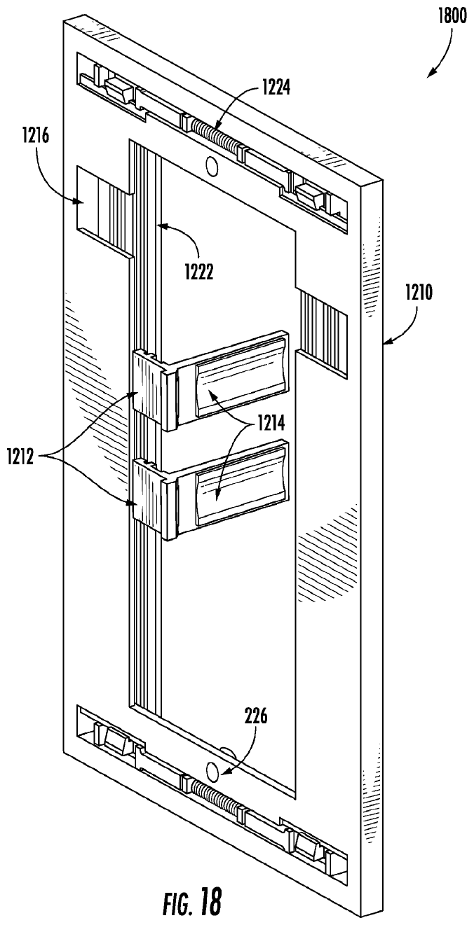

FIG. 18 illustrates another side angle view from the front of a configurable frame 1210 of an alternative embodiment of a wall plate system 1800 such as the wall plate system 100 depicted in FIG. 1A. The configurable frame 1210 includes two terminal connectors 1212 shown on the same power support member 1222 to align the terminal connectors with power terminals of the in-wall wiring device 130. Note that each of the two terminal connectors 1212 shown will connect to different rails on the power support members 1222 to interconnect two different power rails with the wall plate 110. For instance, one of the electrically conductive contacts 1214 of the terminal connectors 1212 may connect with a power phase power terminal 240 and the other one of the electrically conductive contacts 1214 of the terminal connectors 1212 may connect with a neutral power terminal 240. In some embodiment, the terminal connectors 1212 may be marked or labeled with an indication of the power terminal to which the terminal connectors are intended to connect. For instance, the terminal connector 1212 configured to attach to a ground rail may be green, include a character “G” or the word “ground”. The terminal connector 1212 configured to attach to a power phase rail may be black, include a character “B” or characters “BLK” or the word “black”. The terminal connector 1212 configured to attach to a neutral rail may be white, include a character “W” or characters “WHT” or the word “white”.

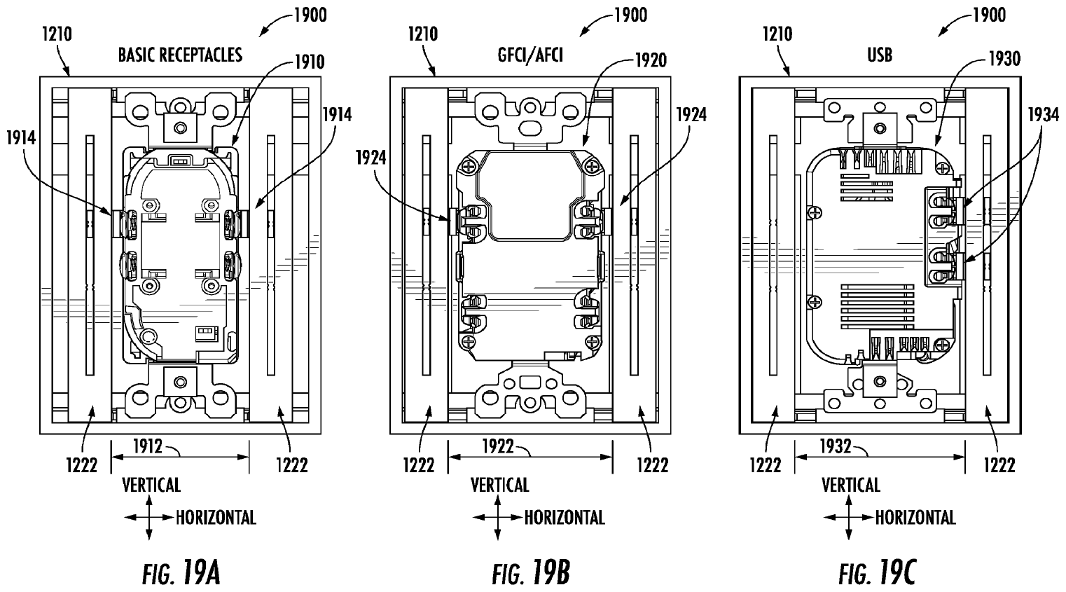

FIGS. 19A-C illustrate back views of a configurable frame 1210 with three different in-wall devices of embodiments of a wall plate system 1900 such as the wall plate system 100 depicted in FIG. 1A. FIG. 19A illustrates a basic receptable configuration for a configurable frame 1210 with the terminal connectors 1914 connected to the power terminals of the in-wall wiring device 1910 with the power support members 1222 at a width of 1912. In this embodiment, one of the terminal connectors 1914 is coupled with each of the power support members 1222.

FIG. 19B illustrates a GFCI/AFCI receptable configuration for a configurable frame 1210 with the terminal connectors 1924 connected to the power terminals of the in-wall wiring device 1920 with the power support members 1222 at a width of 1922. In this embodiment, one of the terminal connectors 1924 is coupled with each of the power support members 1222.

FIG. 19C illustrates a USB receptable configuration for a configurable frame 1210 with the terminal connectors 1934 connected to the power terminals of the in-wall wiring device 1930 with the power support members 1222 at a width of 1932. In this embodiment, both of the terminal connectors 1934 are coupled with the same power support members 1222. Note that the in-wall wiring devices 1910, 1920, and 1930 have three different widths 1912, 1924, and 1934, respectively.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

1. A wall plate apparatus for attaching to an in-wall wiring device, the wall plate comprising:
a frame having a wiring device aperture for receiving the in-wall wiring device when the frame is attached to the in-wall wiring device;
a power support member coupled to a surface of the frame;
a plurality of power rails coupled to the power support member;
a plurality of terminal connectors, wherein the plurality of terminal connectors are each slidably coupled to, and in electrical communication with, a respective power rail the plurality of power rails, wherein the plurality of terminal connectors are each configured to establish electrical communication with corresponding power terminals of the in-wall wiring device when the frame is attached to the in-wall wiring device; and
a wall-plate electrical device coupled to the plurality of power rails.

2. The wall plate apparatus of claim 1, wherein each of the plurality of terminal connectors comprises a spring portion, the spring portion of each of the plurality of terminal connectors configured to exert a contact force on the power terminals of the wiring device to maintain electrical coupling between the power terminals and the terminal connectors.

3. (canceled)

4. (canceled)

5. (canceled)

6. The wall plate apparatus of claim 1, further comprising a wall plate coupled to the frame; wherein the wall-plate electrical device is coupled to the wall plate; and the power support member further comprising first and second power support member, wherein:
the plurality of power rails comprise first and second power rails, wherein:
the first power rail is coupled to the first power support member; and;
the second power rail is coupled to the second power support member;
the plurality of terminal connectors comprise first and second terminal connectors, wherein:
the first terminal connector is slidably coupled to, and in electrical communication with, the first power rail; and
the second terminal connector is slidably coupled to, and in electrical communication with, the second power rail.

7. (canceled)

8. (canceled)

9. The wall plate apparatus of claim 1, wherein the two or more power rails reside within grooves of the one or more power support members.

10. The wall plate apparatus of claim 1, wherein the terminal connectors connect with notches in the one or more power support members to maintain selected positions of the one or more power support members.

11. The wall plate apparatus of claim 1, wherein one or more springs couple with the one or more power support members to apply a force towards the in-wall wiring device;
wherein the frame comprises one or more stops for the one or more power support members to limit narrowing of the wiring device aperture in the frame for the in-wall wiring device to a minimum wiring device aperture width, a maximum wiring device aperture width, or a combination thereof.

12. (canceled)

13. The wall plate apparatus of claim 1, wherein the one or more power support members connect with ratcheting features in the frame to selectively narrow or broaden the wiring device aperture of the frame for the in-wall wiring device.

14. (canceled)

15. The wall plate apparatus of claim 1, wherein one or more walls couple with the one or more power support members and the one or more walls comprise guides to insert wedges between contacts of the terminal connectors and the one or more walls.

16. The wall plate apparatus of claim 1, further comprising one or more wall plate connectors to electrically connect the wall-plate electrical device with the plurality of power rails, wherein the one or more wall plate connectors comprise pogo pins, spring-loaded pins, stabs, or a combination thereof.

17. (canceled)

18. A wall plate system, comprising:
a configurable frame to attach to an in-wall wiring device, the configurable frame having an opening for the in-wall wiring device, the in-wall wiring device comprising power terminals on at least one side of the in-wall wiring device, the configurable frame comprising:
two or more power rails comprising an electrically conductive material;
two or more terminal connectors comprising electrically conductive contacts, wherein each of the terminal connectors is configured to connect to a different one of the two or more power rails;
the one or more power support members coupled with terminal connectors to provide a force towards the in-wall wiring device to maintain electrical connections between the electrically conductive contacts and the power terminals, wherein each of the one or more power support members comprises an electrically insulative material between the two or more power rails to insulate the two or more power rails from each other; and
two or more hidden contacts coupled with the two or more power rails, the two or more hidden contacts to become at least partially exposed to one or more wall plate connectors in response to connection of a wall plate to the configurable frame, wherein each of the two or more hidden contacts is electrically connected to a different rail of the two or more power rails;
the wall plate comprising one or more devices and the one or more wall plate connectors, the one or more wall plate connectors comprising electrically conductive protrusions to connect to the two or more hidden contacts.

19. The wall plate system of claim 18, wherein the two or more power rails reside within grooves of the one or more power support members.

20. The wall plate system of claim 18, wherein the terminal connectors connect with notches in the one or more power support members to maintain selected positions of the one or more power support members.

21. The wall plate system of claim 18, wherein one or more springs couple with the one or more power support members to apply a force towards the in-wall wiring device;
wherein the configurable frame comprises one or more stops for the one or more power support members to stop narrowing of the opening in the configurable frame for the in-wall wiring device at a minimum opening width, a maximum opening width, or a combination thereof.

22. (canceled)

23. The wall plate system of claim 18, wherein the one or more power support members connect with ratcheting features in the configurable frame to selectively narrow or broaden the opening of the configurable frame for the in-wall wiring device.

24. The wall plate system of claim 18, wherein the configurable frame comprises one or more openings to remove or insert one or more of the two or more terminal connectors.

25. The wall plate system of claim 18, wherein one or more walls couple with the one or more power support members and the one or more walls comprise guides to insert wedges between contacts of the terminal connectors and the one or more walls.

26. The wall plate system of claim 18, wherein the one or more wall plate connectors comprise pogo pins, spring-loaded pins, stabs, or a combination thereof.

27. (canceled)

28. A wall plate system, comprising:
an in-wall electrical outlet having two or more power terminals on at least one side of the in-wall electrical outlet;
a configurable frame to attach to the in-wall electrical outlet, the configurable frame having an opening for the in-wall electrical outlet, the configurable frame comprising:
two or more power rails comprising an electrically conductive material;
two or more terminal connectors comprising electrically conductive contacts, wherein each of the terminal connectors is configured to connect to a different one of the two or more power rails;
the one or more power support members coupled with the two or more terminal connectors to provide a force towards the in-wall electrical outlet to maintain electrical connections between the electrically conductive contacts and the two or more power terminals, wherein each of the one or more power support members comprises an electrically insulative material between the two or more power rails to insulate the two or more power rails from each other; and
two or more hidden contacts coupled with the two or more power rails, the two or more hidden contacts to become exposed to one or more wall plate connectors in response to connection of a wall plate to the configurable frame, wherein each of the two or more hidden contacts is electrically connected to a different rail of the two or more power rails;
the wall plate comprising one or more devices and the one or more wall plate connectors, the one or more wall plate connectors comprising electrically conductive protrusions to connect to the two or more hidden contacts.

29. The wall plate system of claim 28, wherein the two or more power rails reside within grooves of the one or more power support members.

30. The wall plate system of claim 28, wherein the two or more terminal connectors connect with notches in the one or more power support members to maintain selected positions of the one or more power support members.

31. The wall plate system of claim 28, wherein one or more springs couple with the one or more power support members to apply the force towards the in-wall electrical outlet;
wherein the configurable frame comprises one or more stops for the one or more power support members to stop narrowing of the opening in the configurable frame for the in-wall electrical outlet at a minimum opening width, a maximum opening width, or a combination thereof.

32. (canceled)

33. The wall plate system of claim 28, wherein the one or more power support members connect with ratcheting features in the configurable frame to selectively narrow or broaden the opening of the configurable frame for the in-wall electrical outlet.

34. The wall plate system of claim 28, wherein the configurable frame comprises one or more openings to remove or insert one or more of the two or more terminal connectors.

35. The wall plate system of claim 28, wherein one or more walls couple with the one or more power support members and the one or more walls comprise guides to insert wedges between contacts of the terminal connectors and the one or more walls.

36. The wall plate system of claim 28, wherein the one or more wall plate connectors comprise pogo pins, spring-loaded pins, stabs, or a combination thereof.

37. (canceled)
